(19) United States
(12) Patent Application Publication
(10) Pub. No.: US 2026/0027491 A1
(43) Pub. Date: Jan. 29, 2026

(54) LIQUEFIED CO2 TERMINAL ARRANGEMENT AND LIQUEFIED CO2 TERMINAL COMPRISING SUCH ARRANGEMENT AS WELL AS METHOD OF TREATING IMPURITIES CONTAINED IN LIQUEFIED CO2 IN A LIQUEFIED CO2 TERMINAL COMPRISING THE ARRANGEMENT

(71) Applicant: HORISONT ENERGI AS, Sandnes (NO)

(72) Inventor: Nikola FELBAB, Sandnes (NO)

(21) Appl. No.: 18/997,203

(22) PCT Filed: Jul. 20, 2023
(86) PCT No.: PCT/EP2023/070099

§ 371 Date: Jan. 21, 2025

(30) Foreign Application Priority Data
Jul. 22, 2022 (EP) 22186558.7

(51) Int. Cl. B01D 5/00; F17C 5/02

(52) U.S. Cl. CPC B01D 5/009; B01D 5/0039; F17C 5/02

(57) ABSTRACT

A liquefied CO2 terminal arrangement is described rendering a liquefied CO2 terminal for carbon capture and storage (CCS) purposes connected via a high-pressure pipeline to a long-term subterranean storage reservoir capable of receiving liquefied CO2 containing impurities, especially incondensibles. Also disclosed is a CO2 terminal incorporating the arrangement, and a method of treating impurities contained in liquefied CO2 in a liquefied CO2 terminal, wherein vapour generated in a liquefied CO2 intermediate storage tank is withdrawn and injected into a high-pressure pipeline connected to a long-term subterranean storage reservoir.

### FIELD OF THE INVENTION

The present invention relates to liquefied CO₂ terminals for carbon capture and storage (CCS) purposes connected via a high-pressure pipeline to a long-term subterranean storage reservoir, and more particularly to a liquefied CO₂ terminal arrangement rendering a liquefied CO₂ terminal capable of receiving liquefied CO₂ containing impurities, especially incondensibles. The invention also relates to a liquefied CO₂ terminal comprising the inventive arrangement, and a method of treating impurities contained in liquefied CO₂ in a liquefied CO₂ terminal, wherein vapour generated in an intermediate storage tank containing liquefied CO₂ is withdrawn and injected into a high-pressure pipeline connected to a long-term subterranean storage reservoir.

### BACKGROUND ART

Existing liquefied CO₂ terminals are designed for food-grade CO₂, which is very pure. Carbon dioxide captured from industrial sites for carbon capture and storage (CCS) purposes, however, contains impurities, as will also liquefied CO₂ produced therefrom, unless purified. Purification of CO₂ to food-grade levels is however costly and typically results in CO₂ emissions. A liquefied CO₂ terminal for CCS purposes should therefore preferably be adapted for industrial CO₂ containing a higher degree of impurities than food-grade CO₂. The liquefied CO₂ received and stored at a CO₂ terminal is in the cold (sub-ambient-temperature) liquid phase and is typically delivered by ship. At the liquefied CO₂ terminal, heat ingress from the surroundings to a container holding the liquefied CO₂ will cause the liquid CO₂ to boil off. To maintain the pressure at a desired level in the container, the boil-off gas must either be reliquefied or removed. Removal of the boil-off gas by venting to atmosphere is not considered preferred, as it would be contrary to the purpose of the CCS chain.

It is accordingly an object of the present invention to provide a liquefied CO₂ terminal for CCS purposes capable of receiving and storing liquefied CO₂ containing impurities.

Some of the impurities contained in the liquefied CO₂ from industrial sites are however volatile “incondensibles”, such as hydrogen, nitrogen, methane, argon, and carbon monoxide, in varying amounts. The vapour that boils off is much richer in the volatile impurities than the liquid (often more concentrated by orders of magnitude). Reliquefaction, which would normally be carried out using standard mechanical refrigeration, involving compressing the boil-off gas, cooling it until it condenses, and then expanding it back into the storage tank, where at least a portion of it is returned as liquid, has been found not to be a feasible option, since with a high concentration of incondensibles, this process would lead to either some venting, or to temperatures that fall below the freezing point of CO₂ to create dry ice, rendering the reliquefaction system inoperable. Removal of the impurities through distillation, which would result in purer CO₂ that can be “easily” reliquefied is energy-intensive, and would result in some venting of CO₂ along with the impurities. Furthermore, it requires additional equipment, and there would also be design and operational difficulties, since the nature, composition, and concentrations of impurities can be different from one incoming liquefied CO₂ cargo to another. Other methods for selectively preventing CO₂ venting, such as pressure swing adsorption, would still vent the impurities which can be environmentally damaging.

The liquefied CO₂ terminal for CCS purposes should therefore be capable of receiving and intermediately storing liquefied CO₂ containing impurities comprising incondensibles, without venting CO₂ or associated impurities.

### SUMMARY OF THE INVENTION

According to the present invention, the above object has been achieved by withdrawing gaseous components from above the liquid phase of liquefied CO₂ contained in a liquefied CO₂ intermediate storage tank, compressing the withdrawn gaseous components, and injecting the compressed gaseous components into a stream of high-pressure liquid or dense-phase CO₂ in a pipeline connected to a subterranean long-term storage reservoir.

Accordingly, in one aspect the present invention relates to a liquefied CO₂ terminal arrangement 100 for use in a liquefied CO₂ terminal 110 comprising: a liquefied CO₂ intermediate storage tank 10 configured to contain liquefied CO₂, having an outlet 20 configured to withdraw liquefied CO₂ from a bottom of the storage tank, and a top outlet 40 configured to withdraw gaseous components from a top of the liquefied CO₂ intermediate storage tank; an injection pump 15, having an inlet 17 connected to the liquefied CO₂ intermediate storage tank outlet, and an outlet 19 connected to a high-pressure pipeline 30 configured to convey high-pressure liquid or dense-phase CO₂ to a subterranean long-term storage reservoir 1, wherein the liquefied CO₂ terminal arrangement 100 comprises a compressor 50 having a low-pressure inlet 53, and a high-pressure outlet 55, said compressor being configured to receive via the low-pressure inlet 53 a flow of gaseous components withdrawn from the liquefied CO₂ intermediate storage tank via the top outlet 40, and to produce from the flow of gaseous components a high-pressure fluid flow leaving from the high-pressure outlet 55, wherein the high-pressure outlet 55 is connected via a high-pressure fluid flow conduit 60 to the high-pressure pipeline 30 and is configured to enter into the pipeline.

In another aspect, the present invention relates to a liquefied CO₂ terminal 120, incorporating therein the liquefied CO₂ terminal arrangement 100 of the invention.

In yet another aspect, the present invention relates to a method for treating impurities contained in liquefied CO₂ in a liquefied CO₂ terminal 120 comprising the steps of: withdrawing a low-pressure stream of gaseous components from a top outlet 40 of a liquefied CO₂ intermediate storage tank 10 containing liquefied CO₂; compressing the low-pressure stream of gaseous components so as to obtain from the low-pressure stream of gaseous components a high-pressure fluid stream; and, injecting the high-pressure fluid stream into a stream of high-pressure liquid or dense-phase CO₂ in a high-pressure pipeline 30 connected to a subterranean long-term storage reservoir 1.

According to the present invention the liquefied CO₂ to be received at the liquefied CO₂ terminal 120 does not need to exhibit a high degree of purity, such as e.g. food-grade purity. Also, the liquefied CO₂ contained in a liquefied CO₂ storage tank 10 in the liquefied CO₂ terminal 120 does not need to be purified before being directed to the subterranean long-term storage reservoir 1.

Also, the invention allows for varying compositions and concentrations of impurities in the liquefied CO₂ received at the terminal 120.

The lower purity requirements of the CO₂ according to the invention will facilitate CO₂ capturing and purification processes at the industrial site.

At the same time, venting of CO₂ and impurities to the atmosphere is avoided.

As illustrated in FIGS. 1 and 3, a liquefied CO₂ terminal could typically include a ship return line or carrier return line for gaseous CO₂.

Further embodiments and advantages of the invention will be apparent from the following detailed description and appended claims.

The term “liquefied CO₂ terminal arrangement” is used herein to denote the parts necessary for implementing the invention into a liquefied CO₂ terminal.

The term “liquefied CO₂ intermediate storage tank” is used herein to denote a tank configured to intermediately store therein liquefied CO₂ before being conveyed to long-term storage in a subterranean storage reservoir.

The term “liquefied CO₂ terminal” is used herein to denote a temporary storage facility configured to be connected via a high-pressure pipeline to a subterranean long-term storage reservoir, and to receive cargoes of liquefied CO₂, typically by a floating vessel, such as a ship. The liquefied CO₂ terminal comprises one or more liquefied CO₂ storage tanks.

The term “long-term storage” is used herein to denote a storage intended for permanent storage of CO₂.

### BRIEF DESCRIPTION OF THE ATTACHED DRAWINGS

FIG. 1 shows a schematic view of a conventional liquefied CO₂ terminal 110.

FIG. 2 shows a schematic view of an embodiment of the inventive liquefied CO₂ terminal arrangement 100.

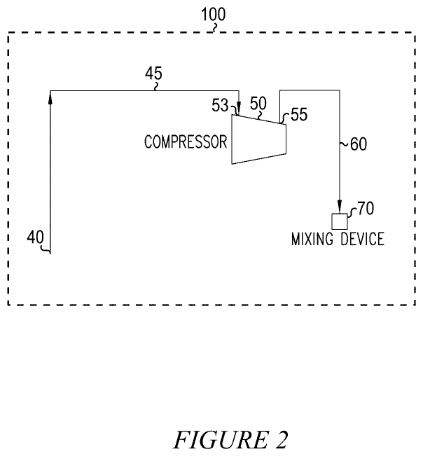

FIG. 3 shows a schematic view of an embodiment of the inventive liquefied CO₂ terminal 120 incorporating the inventive liquefied CO₂ terminal arrangement 100.

In the figures, conduits and pipelines are indicated by lines having an arrow-head showing the direction of the flow of the stream therein.

### DETAILED DESCRIPTION OF THE INVENTION

A liquefied CO₂ terminal 120 for CCS purposes of the invention receives low-to-mid pressure (7 to 18 barg, −55° C. to −20° C.) liquid cargoes of CO₂, typically from a CO₂ carrier, stores the liquid CO₂ temporarily, typically onshore, in one or more liquefied CO₂ intermediate storage tanks 10, and then injects the liquid CO₂ into a high-pressure pipeline 30 leading to a permanent CO₂ storage reservoir 1.

Due to heat ingress from warmer surroundings into the terminal, and into the liquefied CO₂ intermediate storage tanks 10, some of the liquid in the liquefied CO₂ intermediate storage tanks 10 boils off, creating vapour in the tank.

When the CO₂ contains volatile impurities (“incondensibles” such as hydrogen, argon, nitrogen, methane, carbon monoxide), these preferentially enter the vapour phase.

Applying traditional reliquefaction is challenging in this instance, as low temperatures are needed, easily falling below the freezing point of CO₂, and forming dry ice. For this reason traditional reliquefaction is often infeasible.

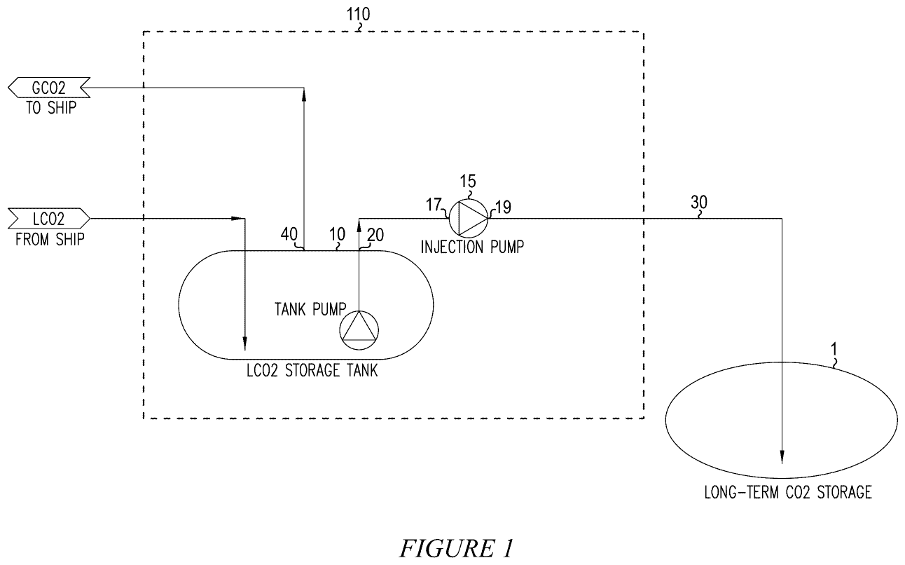

As shown in FIG. 1, a conventional liquefied CO₂ terminal could typically include a ship return line or carrier return line for gaseous CO₂, which return line could be connected to a headspace outlet 40.

The present invention utilizes the fact that the pressure of the liquid or dense-phase CO₂ injected into the pipeline 30 is much higher than in the liquefied CO₂ intermediate storage tank 10, and it can hold more volatile impurities without forming a second phase (vapour).

The pressure of the vapour phase in liquefied CO₂ intermediate storage tank 10 will be much lower than the pressure of the high-pressure liquid or dense-phase CO₂ in the pipeline 30 leading to the subterranean long-term storage reservoir 1. Hence, the high-pressure fluid flow leaving the injection compressor 50 has the capacity for dissolving, or redissolving, therein gaseous components released into the headspace of the liquefied CO₂ intermediate storage tank.

The inventive idea is to compress vapour generated in the liquefied CO₂ intermediate storage tank 10 so as to obtain a high-pressure fluid flow, and via a high-pressure fluid flow conduit 60 inject the resulting high-pressure fluid flow into the high-pressure pipeline 30, preferably at a location on the high-pressure pipeline downstream of the injection pump 15, where the high-pressure fluid flow will be absorbed into the flow of liquefied CO₂ being pumped into the pipeline as high-pressure liquid or dense-phase. The high-pressure fluid flow can be injected into the pipeline simply by means of a T-junction. A mixing-device, such as a static mixer and/or sparger, 70 is preferably used at the location where the high-pressure fluid flow leaving the compressor 50 enters into the high-pressure pipeline 30. The mixing-device is configured to distribute the high-pressure fluid flow into the high-pressure liquid or dense-phase flow so as to ensure rapid dissolution of the high-pressure fluid flow in the flow of liquid or dense-phase CO₂. At the location where the high-pressure fluid flow enters into the flow there should not be any room for a vapour phase, such as a headspace volume, since accumulation or persistence of a vapour phase should be avoided.

Depending on the composition of the vapour drawn from outlet 40 and the conditions at compressor outlet 55, the high-pressure fluid flow can be essentially all vapour, all liquid, or a combination of thereof.

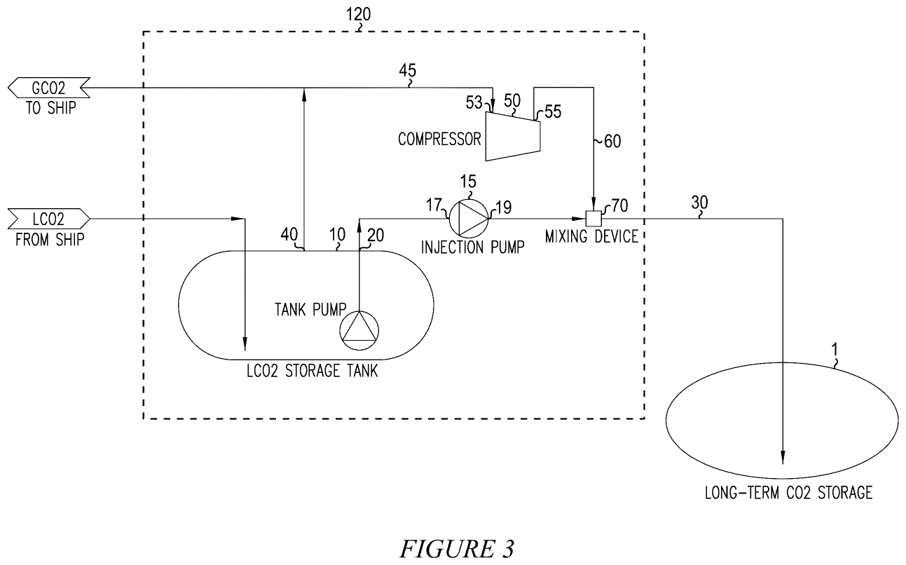

As shown in FIG. 3, a ship return line may typically be included also in a liquefied CO₂ terminal of the invention.

The ratio of the flows of high-pressure liquid or dense-phase CO₂, and high-pressure fluid, respectively, being conveyed into the pipeline should preferably be carefully controlled to ensure that the contents of the pipeline remain single-phase (liquid or dense phase). It is desirable to maintain the pipeline as a single-phase fluid (liquid or dense phase), since this ensures good flow in the pipeline and gives operational flexibility.

The mixing ratio of high-pressure fluid and liquefied CO₂ is preferably controlled by regulating the flow through the injection pump 15 and the compressor 50.

An embodiment of the inventive arrangement 100 incorporated into a liquefied CO₂ terminal 110 will be described in more detail herein below with reference to FIG. 1.

At a liquefied CO₂ terminal 110, 120, a flow of liquefied CO₂ which is contained in liquefied CO₂ intermediate storage tank 10, received e.g. as cargo from a ship, is withdrawn from outlet 20, e.g. by means of a tank pump, and is conveyed via conduit to an injection pump 15. The high-pressure flow of liquid or dense-phase CO₂ is conveyed in a high-pressure pipeline 30, and injected into a long-term subterranean storage reservoir 1. Due to unavoidable heat ingress from warmer surroundings, a portion of the liquefied CO₂ in contained in the liquefied CO₂ intermediate storage tank will boil off, creating an increased pressure within the tank. With the inventive liquefied CO₂ terminal arrangement 100 incorporated into the CO₂ terminal 110, resulting in a liquefied CO₂ terminal 120 of the invention, gaseous components, i.e. carbon dioxide, and impurities, such as one or more of hydrogen, argon, nitrogen, methane, and carbon monoxide, are withdrawn from a headspace outlet 40 of the liquefied CO₂ intermediate storage tank 10 and conveyed via low-pressure conduit 45 to compressor 50, where the flow of gaseous components is compressed. A high-pressure fluid flow leaves the compressor via high-pressure conduit 60, and is injected into the high-pressure flow of liquid or dense phase in high-pressure pipeline 30. Preferably, a mixing device 70 configured to distribute the high-pressure fluid flow into the flow of liquid or dense-phase CO₂ is provided at the location where the two high-pressure flows are combined. The mixing ratio of the two flows can be controlled by regulating the flow through the compressor 50 and/or the flow through the injection pump 15.

Subcooling and respraying technology, as known from e.g. LNG shipping, wherein such technology is used in the LNG tanks, can be used with the invention, e.g. for reducing pressure, cooling, and condensing of vapour in the tank. Such technology could also be used as a back-up in instances when injection of liquefied CO₂ into the long-term storage is temporarily not possible, such as due to failure of parts at the liquefied CO₂ terminal which need to be replaced or repaired. Accordingly, in a preferred embodiment the liquefied CO₂ terminal 120 comprises a liquefied CO₂ subcooler configured to receive liquefied CO₂ from an outlet on storage tank 10, and to return cooled liquefied CO₂ to the tank; and, spraying means inside the storage tank 10, configured to receive cooled liquefied CO₂ and to respray the cooled liquefied CO₂ inside the tank.

As will be readily understood by the skilled reader, the inventive concept is not limited to the use of one storage tank, one compressor, one injection pump, one high-pressure pipeline etc. Depending e.g. on the size and capacity of the liquefied CO₂ terminal 110, 120 there could be more than one of the respective individual parts forming the liquefied CO₂ terminal 120, and the liquefied CO₂ terminal arrangement 100, respectively. For example, while in the embodiment shown in FIG. 3, the injection pump 15 is illustrated as a single pump, and the description herein refers to “an” injection pump, the injection pump 15 used in the invention could be configured as a series of injection pumps. In embodiments with more than one injection pump, the high-pressure outlet 55 is connected via the high-pressure fluid flow conduit 60 to the high-pressure pipeline 30 and is configured to enter into the pipeline preferably at a location on said pipeline downstream of the first injection pump of the series of injection pumps, and more preferably at a location on said pipeline downstream of the last pump of the series of injection pumps.

### LIST OF REFERENCE NUMERALS USED

1 subterranean long-term storage reservoir
10 liquefied CO₂ intermediate storage tank
15 injection pump
17 injection pump inlet
19 injection pump outlet
20 outlet for liquefied CO₂
30 pipeline connected to subterranean long-term storage reservoir
40 top (headspace) outlet for withdrawal of gaseous components
45 low-pressure conduit connecting storage tank top outlet to compressor inlet
50 compressor for compressing gaseous components withdrawn from storage tank
53 compressor inlet for gaseous components withdrawn from storage tank
55 compressor outlet for high-pressure fluid flow
60 high-pressure conduit connecting compressor outlet with high-pressure pipeline 30
70 mixing device
100 liquefied CO₂ terminal arrangement
110 liquefied CO₂ terminal
120 liquefied CO₂ terminal including liquefied CO₂ terminal arrangement 100

1. A liquefied CO₂ terminal arrangement for use in a liquefied CO₂ terminal comprising:
a liquefied CO₂ intermediate storage tank configured to contain liquefied CO₂, having an outlet configured to withdraw liquefied CO₂ from a bottom of the liquefied CO₂ intermediate storage tank, and a top outlet configured to withdraw gaseous components from a top of the liquefied CO₂ intermediate storage tank; and
an injection pump, having an inlet connected to the liquefied CO₂ intermediate storage tank outlet, and an outlet connected to a high-pressure pipeline configured to convey liquefied CO₂ to a subterranean long-term storage reservoir;
wherein the liquefied CO₂ terminal arrangement further comprises a compressor having a low-pressure inlet, and a high-pressure outlet, said compressor being configured to receive via the low-pressure inlet a flow of gaseous components withdrawn from the liquefied CO₂ intermediate storage tank via the top outlet, and to produce from the flow of gaseous components a high-pressure fluid flow leaving from the high-pressure outlet, wherein the high-pressure outlet is connected via a high-pressure fluid flow conduit to the high-pressure pipeline and is configured to enter into the pipeline.

2. The liquefied CO₂ terminal arrangement for use in a liquefied CO₂ terminal of claim 1, wherein the high-pressure outlet connected via the high-pressure fluid flow conduit to the high-pressure pipeline is configured to enter into the pipeline at a location on said pipeline, which location is downstream of the injection pump.

3. The liquefied CO₂ terminal arrangement of claim 1, additionally comprising a mixing device configured to distribute the high-pressure stream of gaseous components from the compressor into the flow of liquid or dense-phase CO₂ in the high-pressure pipeline.

4. A liquefied CO₂ terminal comprising:
a liquefied CO₂ intermediate storage tank configured to contain liquefied CO₂, having an outlet configured to withdraw liquefied CO₂ from a bottom of the liquefied CO₂ intermediate storage tank, and a top outlet configured to withdraw gaseous components from a top of the liquefied CO₂ intermediate storage tank; and
an injection pump, having an inlet connected to the liquefied CO₂ intermediate storage tank outlet, and an outlet connected to a high-pressure pipeline configured to convey liquid or dense-phase CO₂ to a subterranean long-term storage reservoir;
wherein the liquefied CO₂ terminal further comprising a compressor having a low-pressure inlet, and a high-pressure outlet, said compressor being configured to receive via the low-pressure inlet a flow of gaseous components withdrawn from the liquefied CO₂ intermediate storage tank via the top outlet, and to produce from the gaseous components a high-pressure fluid flow of the gaseous components leaving from the high-pressure outlet, wherein the high-pressure outlet is connected via a high-pressure fluid flow conduit to the high-pressure pipeline and is configured to enter into the pipeline.

5. The liquefied CO₂ terminal of claim 4, wherein the high-pressure outlet connected via the high-pressure fluid flow conduit to the high-pressure pipeline is configured to enter into the pipeline at a location on said pipeline, which location is downstream of the injection pump.

6. The liquefied CO₂ terminal of claim 5, additionally comprising a mixing device configured to distribute the high-pressure fluid flow from the compressor into the flow of liquid or dense-phase CO₂ in the high-pressure pipeline.

7. The liquefied CO₂ terminal of claim 5, additionally comprising: a liquefied CO₂ subcooler configured to receive liquefied CO₂ from an outlet on the liquefied CO₂ intermediate storage tank, and to return cooled liquefied CO₂ to the liquefied CO₂ intermediate tank; and, spraying means inside the liquefied CO₂ intermediate storage tank, configured to receive cooled liquefied CO₂ and to respray the cooled liquefied CO₂ inside the liquefied CO₂ intermediate storage tank.

8. A method for treating impurities contained in liquefied CO₂ in a liquefied CO₂ terminal comprising the steps of:
withdrawing a low-pressure stream of gaseous components from a top outlet of a liquefied CO₂ intermediate storage tank-containing liquefied CO₂;
compressing the low-pressure stream of gaseous components so as to obtain a high-pressure fluid stream; and,
injecting the high-pressure fluid stream into a high-pressure stream of liquid or dense-phase CO₂ in a high-pressure pipeline connected to a subterranean storage reservoir.

9. The method for treating impurities contained in liquefied CO₂ in a liquefied CO₂ terminal of claim 8, additionally comprising the step of:
regulating the mixing ratio of the high-pressure stream of gaseous components to the high-pressure stream of liquefied CO₂ in the pipeline connected to the subterranean storage reservoir so as to dissolve the gaseous components into the liquefied CO₂, thereby obtaining a single phase in the high-pressure pipeline.

10. The method for treating impurities contained in liquefied CO₂ in a liquefied CO₂ terminal of claim 8, additionally comprising the steps of:
withdrawing a flow of liquefied CO₂ from an outlet on the liquefied CO₂ intermediate storage tank;
subcooling the flow of liquefied CO₂ withdrawn from the outlet on the liquefied CO₂ intermediate storage tank-thereby obtaining a cooled flow of liquefied CO₂; and,
returning the cooled flow of liquefied CO₂ to the liquefied CO₂ intermediate storage tank by respraying the liquefied CO₂ into the headspace of the liquefied CO₂ intermediate storage tank.
